(19) United States
(12) Patent Application Publication
(10) Pub. No.: US 2006/0074777 A1
(43) Pub. Date: Apr. 6, 2006

(54) System including a handheld device for checking inventory of vending machines

(76) Inventor: Eric E. Anderson, St. Louis, MO (US)

Correspondence Address: Raymond M. Galasso;Simon, Galasso & Frantz PLC, P.O. Box 26503, Austin, TX, 78755-0503, US

(21) Appl. No.: 10/958,579

(22) Filed: Oct. 5, 2004

(51) Int. Cl. G06F 17/60

(52) U.S. Cl. 705/28

(57) ABSTRACT

A system for facilitating the monitoring and managing of the inventory of vending machines utilizing a handheld inventory checker capable of communicating with the vending machines to communicate therebetween data corresponding to the remaining inventory of each checked vending machine. The handheld inventory checker includes software to monitor the inventory and based upon the data received from the communications from the vending machine, calculate and display the type and number of required items to be restocked in each particular vending machine.

### FIELD OF THE INVENTION

The present invention relates to system and devices for checking inventory of vending machines, and more particularly, but not by way of limitation, to a handheld device for checking and managing the inventory of vending machines.

### BACKGROUND

A vending machine will contain items to be sold or vended to a customer. Various types of items are dispensed by vending machines, including hot and cold snacks, hot and cold beverages, sandwiches, and various types of merchandise including newspapers and stamps, just to name a few. In the vending machine business, the owner or operator of the vending machines are responsible for visiting the site of the vending machine to not only empty the money out of the machine, but to also maintain sufficient inventory. For example, one site, such as an office building, could have numerous vending machines to be serviced. Usually the operator will load a cart with items that he thinks the on-site vending machines will need. The operator then goes from machine to machine opening each to check and replace the inventory. Since the use of vending machines varies not only from vending machine to vending machine, but also from visit to visit the operator will often not have the right inventory immediately at hand to fill the machines. The solution is to either close up the machine and retrieve the needed additional items and return, or leave the machine lacking certain items until the next visit.

It would be advantageous therefore, to develop a device or apparatus that can be used to readily and accurately determine the inventory of a vending machine.

### BRIEF DESCRIPTION OF THE DRAWING FIGURES

A more complete understanding of the present invention may be had by reference to the following Detailed Description and appended claims when taken in conjunction with the accompanying Drawings wherein:

FIG. 1 is a block diagram illustrating an vending machine and handheld inventory checker constructed in accordance with the principles of the present invention; and

FIG. 2 is an enlarged perspective view of a handheld vending machine inventory checker constructed in accordance with the principles of the present invention as similarly shown in FIG. 1.

### DETAILED DESCRIPTION

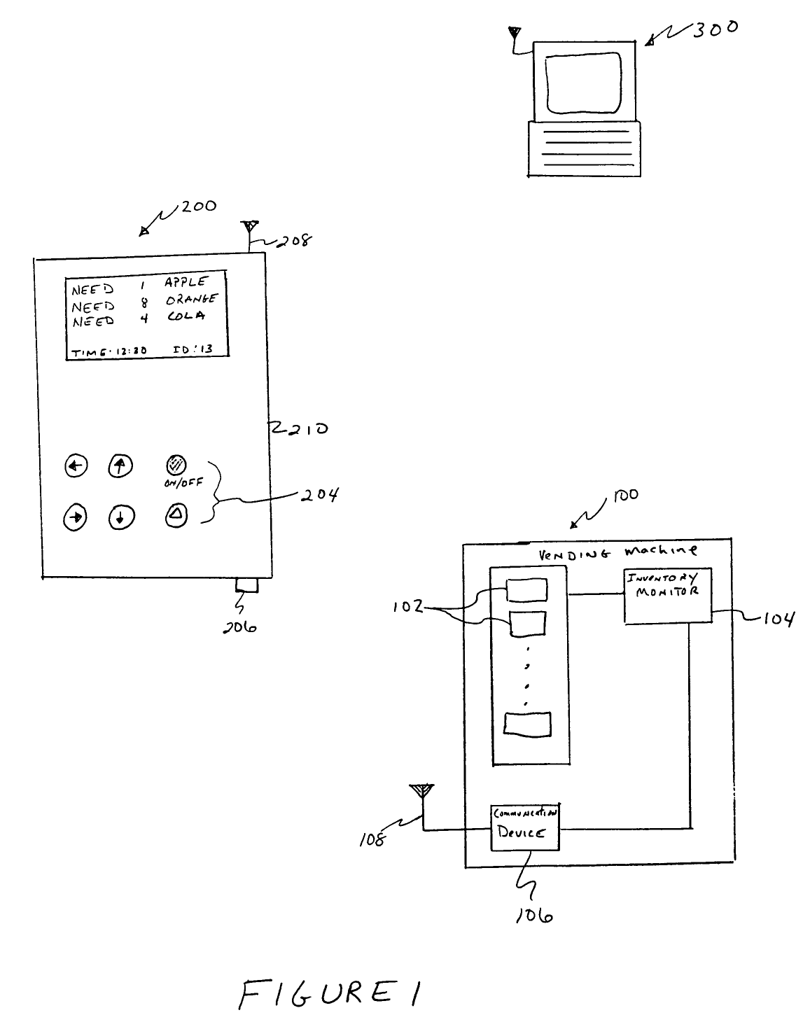

Referring now to the drawings wherein like or similar elements are designated with identical reference numerals throughout the several views and figures, and wherein the various elements depicted are not necessarily drawn to scale, and in particular, to FIG. 1, there is shown a vending machine 100 and a handheld inventory checker 200 in accordance with the principles of the present invention. Vending machine 100 is designed to dispense items 102 as chosen by a user or purchaser. As can be appreciated vending machine 100 could be virtually any type of vending machine, including, but not limited to a beverage vending machine, food or snack vending machine, medicine vending machine, and a merchandise vending machine.

Vending machine 100 includes an inventory monitor 104. Inventory monitor 104 is designed to keep track of various matters pertaining to the inventory of the items 102 stored in the vending machine. Such matters include a real time inventory or count of each item 102, the total number of items 102, the total number of items 102 initially loaded into the vending machine each time filled, any possible expiration dates of items 102, the time and date of the purchase of items 102. It is anticipated that items 102 could be either all one type of an item, such would be the case with a newspaper vending machine, or items 102 could be a variety of items, such would be the case with a snack or beverage vending machine. Vending machine 100 further includes a communication device which interfaces with inventory monitor 104.

As illustrated handheld inventory checker 200, includes a display 202, a control panel 204, a holder 206, and a communication interface 208. In operation, vending machine 100 would be initially stocked with items 102, and the inventory monitor 104 would update the data that it is designed to monitor (such as described in the hereinabove). After a select period of time, the owner or operator of the vending machine 100 would return to restock the vending machine. Once the operator is within a certain distance from the vending machine 100, the handheld checker 200 and the vending machine 100 would communicate therebetween. The information or data stored in the inventory monitor 104 would be communicated to the handheld checker 200, whereby at least a portion of the data could then be displayed on display 202. The data would allow the user to display on display 202, such information as: the items that have been sold from the vending machine 100; the number of items remaining in the vending machine 100; and expired items: and, the number and type of items needed to restock the vending machine 100. It is contemplated that handheld checker 200 could also be programmed to recommend different items to be placed in a particular vending machine based on historical sales of items.

As many vending machine owner/operators generally have or service more that one vending machine, a unique electronic ID could be assigned to each vending machine 100 such when the data stored in the inventory monitor 104 is communicated to the handheld checker 200, the handheld checker 200 will be able to properly identify the data associated with each machine.

Vending machine 100 and handheld checker 200 can be configured to communicate by using various types of communications. For example, a wireless connection (such as with an 802.11x or blue tooth protocol) could utilized to established a communication connection between vending machine 100 and handheld checker 200, which would be facilitated, in part by antenna 108 of vending machine 100 and antenna 208 of handheld checker 200. It is further contemplated that a physical or wired connection could also be utilized for the communications between vending machine 100 and handheld checker 200. In addition, handheld checker 200 could also be configured to communicate in either wireless or wired manner with a computer 300 or long term electronic storage device, where the user could download and store all the data received from their vending machines.

An advantage of a vending machine 100 and handheld checker 200 utilizing a wireless communication, would be that the user could check the inventory of multiple vending machines all located within a select range at the same time, thereby saving time in preparing to restock the vending machines.

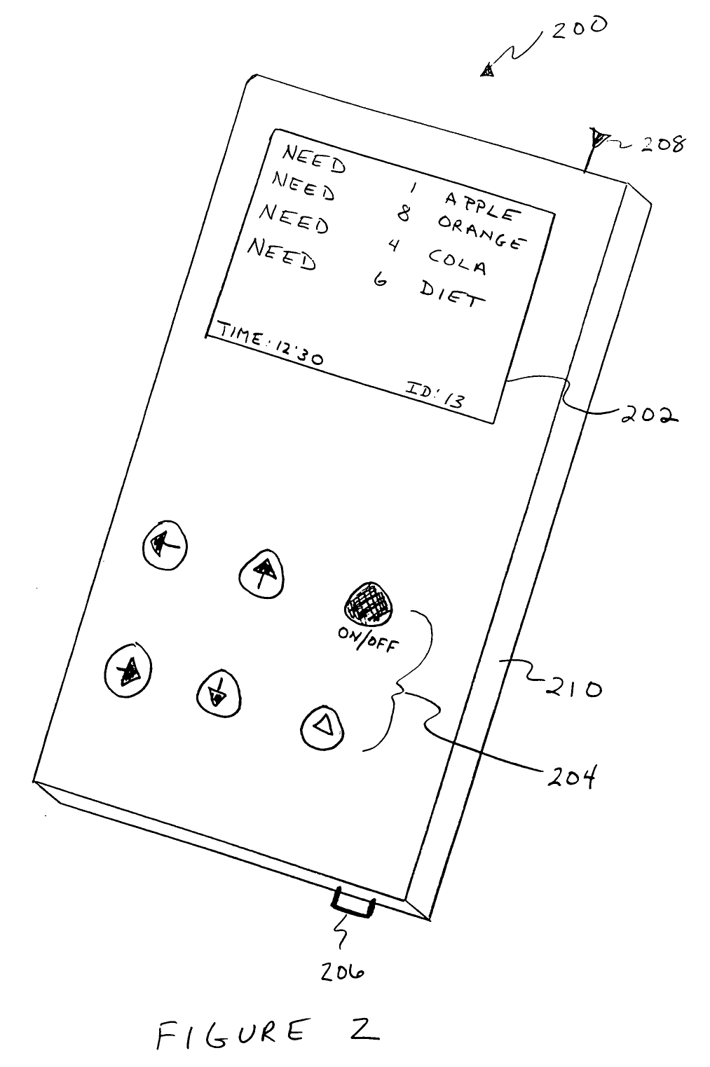

Referring now to FIG. 2, there is an exemplary embodiment of the handheld checker 200. As illustrated handheld checker 200 includes a display 202 for displaying information gathered and processed to the user. Examples of displayed items would be machine id number, time and date, items and quantity of each needed for that machine, expiration dates for remaining items, location of machine, and virtually any type of data determined to be useful to the user. As further illustrated, handheld checker 200 includes a control panel 204 for facilitating a user to control the operations of handheld checker 200 as well as for facilitating user input. The user, among other things, would be able to activate the operation of handheld checker 200 for checking inventories, and would enable control of the items displayed on display 202 such as by scrolling the items in display. Control panel 204 could also include a power switch for turning on/off the handheld checker 200.

As further illustrated in FIG. 2, handheld checker 200 includes a device holder 206 to facilitate a strap connected to it or for enable hanging handheld checker 200 on a hook or other type of hanging device.

As described above, handheld checker 200 includes a communication interface 208 for the transferring of data between handheld checker 200 and the vending machine 100 or computer 300. Although communication interface 208 is illustrated as a wireless interface, it is contemplated to be within the scope of this invention that a wired interface could also be utilized.

In an exemplary embodiment of the present invention, handheld inventory checker 200 is microprocessor controlled handheld computer with software that would enable it to browse, query and obtain information corresponding to a vending machine's inventory, process the data, and display, to the user, information corresponding to data received from the vending machine. It is contemplated that outer casing 210 of handheld checker 200 would be constructed a durable material, such as hard plastic, and that a transparent protective covering would also be utilized over display 202.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A device for checking the inventory of vending machines, said device comprising:
a communicator for facilitating the transfer of data between the device and the vending machine;
a display for displaying information corresponding to data transferred from the vending machine; and
a control panel for facilitating user input into the device.

2. The device as recited in claim 1, wherein said communicator includes a wireless communication system for facilitating wireless data communications between the device and the vending machines.

3. The device as recited in claim 1, wherein said communicator includes a network port for facilitating wired data communications between the device and the vending machines.

4. The device as recited in claim 1, and further including software for processing at least a portion of the data received from the vending machines to determine needed inventory of the vending machines.

5. The device as recited in claim 1, wherein said communicator includes a wireless communication system for facilitating wireless data communications between the device and the vending machines; and the device includes software for processing at least a portion of the data received from the vending machines to determine needed inventory of the vending machines.

6. A system for monitoring and managing the inventory of vending machines, said system comprising:
an inventory monitoring device within at least one vending machine for monitoring the inventory of goods of the at least one vending machine;
a communication device within the at least one vending machine connected to the inventory monitoring device; and
a handheld inventory checker, the handheld inventory checker including a communication device, wherein said communication device of the handheld inventory checker and the communication device of the vending machine facilitate data communications between the vending machine and the handheld inventory checker.

7. The system as recited in claim 6, wherein said handheld inventory checker includes a control panel for user input.

8. The system as recited in claim 6, wherein each of said communication device of the handheld inventory checker and the communication device of the vending machine include a wireless communication device to facilitate wireless communication between the handheld inventory checker and the vending machine.

9. The system as recited in claim 6, and further including a computer, said computer capable of communication with the handheld inventory checker.

10. The system as recited in claim 6, wherein said handheld inventory checker includes software for processing at least a portion of the data received from the at least one vending machine to determine needed inventory of the vending machine.

11. The system as recited in claim 10, wherein said software further for monitoring historical inventory of the at least one vending machine.

12. The system as recited in claim 11, wherein said software further for projecting future inventory based upon the historical inventory of the at least one vending machine.

13. The system as recited in claim 6, wherein said at least one vending machine includes an identification code.

14. A system for monitoring and managing the inventory of vending machines, said system comprising:
an inventory monitoring device within at least one vending machine for monitoring the inventory of goods of the at least one vending machine;
a communication device within the at least one vending machine connected to the inventory monitoring device;
a handheld inventory checker, the handheld inventory checker including a communication device, wherein said communication device of the handheld inventory checker and the communication device of the vending machine facilitate data communications between the vending machine and the handheld inventory checker; and
software for processing data corresponding to inventory of goods.

15. The system as recited in claim 14, wherein at least a portion of the software is in the handheld inventory checker.

16. The system as recited in claim 15, wherein said handheld inventory checker includes a control panel for user input and a display for displaying to the user at least data corresponding to the inventory of goods of the at least one vending machine.

17. The system as recited in claim 16, wherein each of said communication device of the handheld inventory checker and the communication device of the vending machine include a wireless communication device to facilitate wireless communication between the handheld inventory checker and the vending machine.

18. The system as recited in claim 17, wherein said software further for monitoring historical inventory of the at least one vending machine.

19. The system as recited in claim 18, wherein said software further for projecting future inventory based upon the historical inventory of the at least one vending machine.

20. The system as recited in claim 19, wherein said at least one vending machine includes an identification code.
